(19) United States
(12) Patent Application Publication
(10) Pub. No.: US 2009/0089211 A1
(43) Pub. Date: Apr. 2, 2009

(54) SYSTEM AND METHOD FOR PERSON TO PERSON FUND TRANSFER

(76) Inventor: Patricia Morse, San Jose, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/866,364

(22) Filed: Oct. 2, 2007

(51) Int. Cl. G06Q 40/00; G06F 17/30; G06F 17/40

(52) U.S. Cl. 705/41; 705/44

(57) ABSTRACT

A system, apparatus, and method for providing payment for goods or services via a transfer of funds from a payer to a payee. In some embodiments, the invention includes establishing a deposit account for a prospective payee which may be accessed by a payer using payment receipt data provided by the payee. The deposit account may be configured to permit only deposits to the account, with no withdrawal or transfer out of funds possible. The deposit account may be associated with a credit card, debit card, or checking account, or may be a separate account.

### BACKGROUND

The present invention is directed to systems, apparatus and methods used to provide payment for goods or services, and more specifically, to a system and associated apparatus and method for transferring funds between parties to a transaction using a deposit account associated with the intended recipient of a payment. The invention may be used instead of a standard credit card, debit card, personal check, cash or an intermediary payment system to facilitate a transfer of funds to a designated recipient using the recipient's deposit account. The information used to access the deposit account is provided by the intended recipient to the party making a payment for the good or service, or otherwise desiring to transfer funds to the recipient.

In many transactions involving goods or services, a buyer makes a payment to a seller or service provider by providing the seller or service provider with information about a buyer's account from which a payment may be deducted, withdrawn or against which a credit may be placed. In each case a payment mechanism is used by the buyer (or “payer”) to enable a payment to be made to the recipient (or “payee”). Examples of payment mechanisms include personal checks (which result in a withdrawal of funds from the payer's account when presented to a bank or similar institution), credit cards (which result in placement of a charge or credit against the payer's account when transaction related data is processed), and debit cards (which result in a deduction from the payer's account when transaction related data is processed). Further examples of payment mechanisms include intermediary networks such as Paypal™ which process transaction related data and apply a charge or credit against the payer's account. In all of the above cases, the payment process follows a common paradigm; a buyer uses some form of payment mechanism to enable the intended recipient of the payment to obtain the agreed upon funds by instituting a charge against or deduction from the buyer's account. In this paradigm, the payer provides the payee with account related data that may be used to cause the charge against or deduction from the payer's account. The payee then submits the account related data to an agent responsible for settling the transaction, where that agent typically coordinates the placement of a charge against a credit balance or deduction from a debit account.

FIG. 1 is a flowchart illustrating a prior art process for enabling a payer to provide payment to a payee in return for providing a good or service. As shown in the figure, such a process typically includes a payer establishing an account with a bank, financial institution, payment processing organization, intermediary network, or the like (stage 102). The payer account may be one or more of a checking account, credit card account, debit card account, or the like. In each case a payment mechanism is associated with the payer account, where the payment mechanism may be one or more of a personal check, credit card, debit card, or the like (stage 104). The payment mechanism may have an associated account number or other identifying data that may be used for purposes of authentication and/or authorizing a party to a transaction to receive payment from the payer's account (stage 104). Such data is typically provided to an intended payee using the associated payment mechanism (such as a credit/debit card or personal check), but in some cases may be provided directly by the payer over a network connection, such as the Internet (in the case of an eCommerce transaction or wire transfer, for example). By selecting a desired product or service and agreeing to provide the payment mechanism data (e.g., an account number, credit card number, etc.) to the payee, the payer and payee enter into an agreement or transaction to exchange a good or service in return for payment (typically in the form of a transfer of funds from the payer to the payee) (stage 106). In a typical transaction, the payer provides the payment mechanism data and if required, other data (such as identification or security/authentication data) to the payee (stage 108). The payee then uses the payment mechanism data to settle the transaction (stage 110), often by submitting the data or payment mechanism itself to the proper institution or payment network.

For example, in the case of a payer using a credit card account, the payer first establishes a credit card account with a bank or other institution. The payer is then issued a credit card that may be used to make purchases of goods or services. The payer presents the credit card and/or account data to a merchant at the point of sale, or provides the relevant account data remotely to the merchant via the Internet or another data network. The account data is typically used to authorize the purchase, verify the identity of the payer, and provide access to funds used to settle the transaction (e.g., by causing a charge to be placed against the payer's account which the payer settles by transferring funds into that account using a personal check, automated transfer, or other mechanism). A debit card or personal check is used in a similar manner, with a difference being that instead of a charge or credit against an account being made, a deduction from an account is made after processing of the transaction data.

However, regardless of how it is provided, the payment mechanism data is used in the same general manner; it is presented by the payer to the payee, and then presented by the payee to a payment processing organization or other financial institution where it is used to deduct or withdraw funds, or otherwise place a demand for payment on the payer's account. Although this method of providing payment is effective and generally accepted by prospective payers and payees, it does have some disadvantages. Perhaps the greatest disadvantage is that in the event of a breach in security, demand for payment may be made against a person's account in situations in which the person did not authorize or otherwise agree to payment. Such a situation may arise, for example, if a person's credit card information is misappropriated as a result of a “phishing” attack over the Internet, if their card is lost or stolen and used fraudulently, if a check is stolen and a signature is forged to obtain payment, etc. In addition, the account information may be misappropriated from or mishandled by an intermediary institution such as a bank or payment processor whose security measures may not be sufficient. Thus, lack of security and the possible misappropriation of personal account data are significant disadvantages of present approaches to transferring funds between parties to a transaction.

What is desired are a system and associated apparatus and method for enabling a party to provide payment for a transaction involving goods or services, or otherwise transfer funds, and that overcomes the disadvantages of the present approaches.

### BRIEF SUMMARY

The present invention is directed to systems, apparatus, and methods for providing payment for goods or services via a transfer of funds from a payer to a payee. In some embodiments, the invention includes establishing a deposit account for a prospective payee which may be accessed by a payer using payment receipt data provided by the payee. The deposit account may be configured to permit only deposits to the account, with no withdrawal or transfer out of funds possible by any person other than the account holder. The deposit account may be associated with a credit card, debit card, or checking account, or may be a separate account.

In one embodiment, the present invention is directed to a method of enabling a transfer of funds from a payer to a payee, where the method includes establishing a deposit function associated with a payee account, the deposit function configured to permit a party other than the payee to only deposit funds into the payee account, associating payment receipt data with the deposit function, receiving the payment receipt data from the payer, receiving identification of an account from which the payer desires to transfer funds into the payee account, receiving authorization from the payer to transfer the funds, and transferring the funds into the payee account.

In another embodiment, the present invention is directed to a financial services product, where the product includes an account having an account holder and an associated deposit function, the deposit function identified by identifying data and configured to permit a party other than the account holder to only make deposits into the account in response to the party providing the identifying data.

In yet another embodiment, the present invention is directed to a system for the transfer of funds from a payer to a payee, where the system includes means for establishing a deposit account associated with the payee, means for associating the deposit account with identifying data, means for receiving the identifying data from the payer, and a fund transfer manager configured to receive a fund transfer instruction, an identification of a payer account from which to transfer the funds, and the identifying data, and in response, to authorize the transfer of the funds from the payer account to the deposit account.

Other objects and advantages of the present invention will be apparent to one of ordinary skill in the art upon review of the detailed description of the present invention and the included figures.

### BRIEF DESCRIPTION OF THE DRAWINGS

FIG. 1 is a flowchart illustrating a prior art process for enabling a payer to provide payment to a payee for providing a good or service;

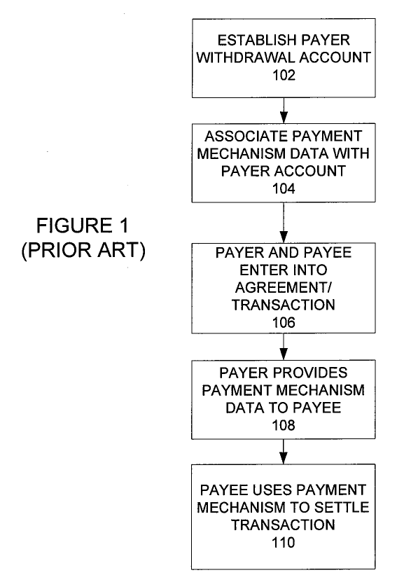

FIG. 2 is a flowchart illustrating a method of enabling a payee to receive payment from a payer using a deposit account in accordance with some embodiments of the present invention;

FIG. 3 is a functional block diagram illustrating elements of a system that may be used to implement the inventive method, in accordance with some embodiments of the present invention; and

FIG. 4 is a flowchart illustrating the use of an escrow and/or dispute resolution entity as part of the method of FIG. 2, in accordance with some embodiments of the present invention.

### DETAILED DESCRIPTION

The present invention is directed to systems, apparatus, and methods for enabling a transfer of funds between two parties in a secure manner, typically between a payer and a payee in return for the payee providing an agreed upon good or service. The present invention may also be used to transfer funds between two parties for other purposes as well, for example, as part of a loan or gift of money.

Various embodiments of the invention represent implementations of a different paradigm for the transfer of funds; instead of the present model of a payer providing payment account data to a payee which is used in some manner to cause a charge against or a withdrawal from the payer's account, the invention instead enables a fund transfer in the form of a deposit into a designated payee account. This model for a fund transfer provides a secure method of payment that eliminates certain of the disadvantages of the current “withdrawal” model. Firstly, it eliminates the risk of a breach of security or fraudulent activity, as funds can only be put into an account instead of being withdrawn. As a result, even if confidential account data is somehow obtained by a party not entitled to that information, the information can not be used to obtain funds.

A further advantage is that in some embodiments, a transfer of funds may be accomplished without needing to visit a bank or other physical location to cash a check or deposit funds into an account. In some embodiments, this functionality may be achieved by adding a deposit-only feature to an existing credit or debit card account. This would permit a user of a credit or debit card account to receive a transfer of money into their deposit account (which could then be made available for credit or debit purchases). The source of funds for the transfer could be, for example, a wire transfer from a bank, a credit card account advance, a deduction from a debit card account, or other suitable mechanism.

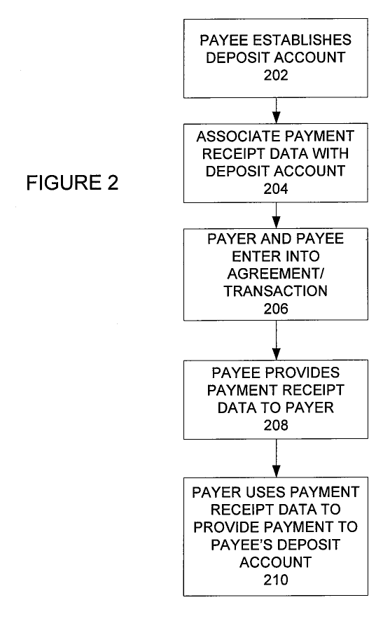

FIG. 2 is a flowchart illustrating a method of enabling a payee to receive payment from a payer using a deposit account in accordance with some embodiments of the present invention. As shown in the figure, the method typically begins with a prospective payee (that is, a party wishing to set up an account having the ability for others to deposit or otherwise transfer funds into the account) establishing a deposit account (stage 202). The deposit account may be a separate account or an additional functionality provided for an existing account. For example, the deposit account may be implemented as a deposit-only function that is part of a credit or debit card account. This would permit the holder of a credit or debit card account to arrange for a transfer of funds into the deposit account, without risk of an unauthorized withdrawal from their other accounts. Regardless of the specific implementation, the deposit account is configured to operate so that upon providing specified account data to a party, that party may use the account data to deposit funds into the deposit account. The mechanism by which funds are transferred to the account may utilize an intermediary such as a bank or financial services network, payment processing network, wire transfer, or other suitable method.

After establishing the deposit account or deposit function for another account, payment receipt data is associated with the account (stage 204). The payment receipt data may be identification, authorization, or another form of account related data that can be used in making a deposit or otherwise transferring funds into the deposit account. The payment receipt data is typically associated with a payment receipt mechanism, which may be used to transfer the payment receipt data to a prospective payer. The payment receipt mechanism may also function as a data storage mechanism for account data, such as an account balance. The payment receipt mechanism may be a credit card, debit card, or other suitable form of personal data device. For example, the payment receipt mechanism may be a form of electronic wallet such as might reside in a SIM (subscriber identity module) card, smart card, or memory of a mobile phone or other portable device, a memory device which stores an indication of an account balance (such as a pre-paid balance card or device, re-loadable balance card or device), etc. In a typical transaction, the payment receipt mechanism may be used with a data access device (e.g., a kiosk, card reader, ATM machine, etc.) to provide the deposit account data to the payer for purposes of identifying the account into which funds are to be transferred, and to maintain account balance data for the payee.

Next, an agreement, transaction or other form of activity in which it is desired to transfer funds (e.g., a loan, payment for goods or services, cash advance, electronic transfer of funds, etc.) is initiated between a first party and a second party (e.g., a payer and a payee), as shown at stage 206. The transaction may be a sale of a good or provision of some service, for example. At an appropriate stage in the transaction, the payee who is the intended recipient of the funds provides the payment receipt data (e.g., the account number or other identifying data for the deposit account or corresponding to the deposit feature of an account) to the payer, as shown at stage 208. Note that in some embodiments, the payment receipt or deposit account data may be, for example, a modification of an existing card account number (such as may be created by appending a character or characters to a credit or debit card number), a string of alphanumeric characters, a string of characters generated from a credit or debit card number, a string of characters generated from user account data or inputs, or other suitable data. Note that for purposes of maintaining security and preventing fraud, it is generally desirable to avoid any direct or readily discoverable association between the credit or debit card account number and the deposit account number or data. By associating a credit or debit card account with a deposit-only function, the arrangement permits a credit or debit card account to serve both credit/debit and deposit functions. In such a situation, the same institution (bank, financial institution, payment processing network) that manages a user's credit or debit card accounts could also manage the deposit function account, providing settlement and account administration functions as required.

After receiving the payee's payment receipt data, the payer uses that data to provide payment for the goods or services, or otherwise transfer funds to the payee's deposit account (stage 210). The fund transfer is typically implemented by an intermediary, such as a financial institution, payment processing network, or other entity capable of performing some or all of the functions required for the transfer of funds from a designated account into the deposit account. Note that the payer and payee may be companies, groups, organizations, or individuals, and that in some embodiments, the transfer of funds may be accomplished without the use of an additional payment network (such as Paypal™).

For example, if both the payer and payee have credit or debit card accounts, with the payee's account having an associated deposit function, then funds may be transferred from the payer to the payee's deposit account by placing a charge against the payer's credit card account or causing a deduction from the payer's debit card account. In such a transaction, the payment processing network which manages the standard credit or debit transactions may be used for the transfer of funds into the deposit account, thereby removing the necessity for an additional payment processing network.

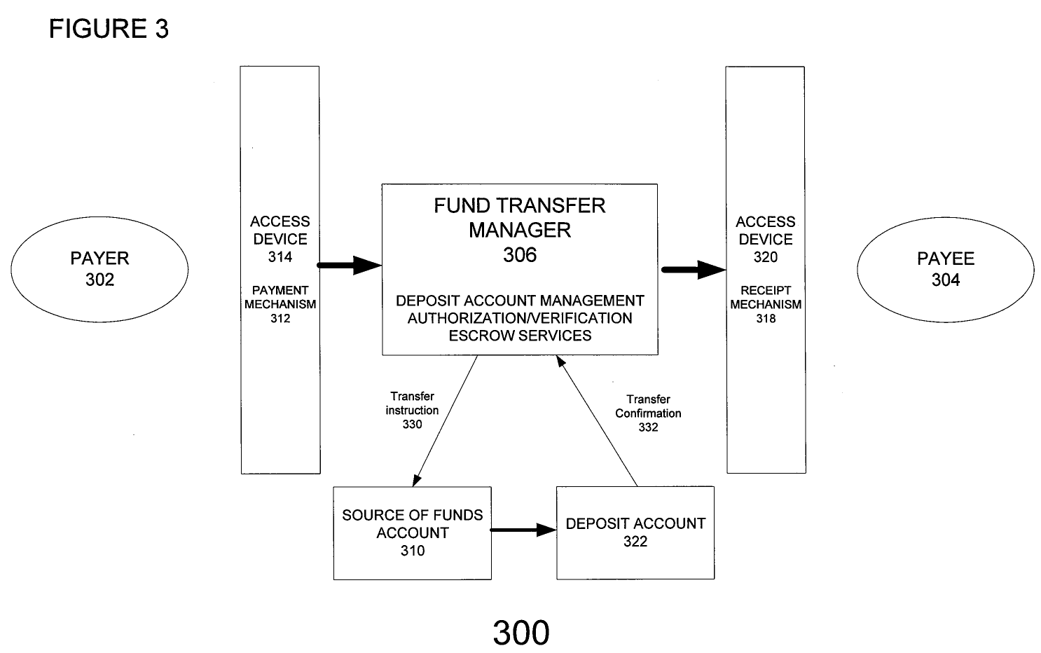

FIG. 3 is a functional block diagram illustrating elements of a system 300 that may be used to implement the inventive method, in accordance with some embodiments of the present invention. As shown in the figure, system 300 may be utilized to transfer funds between a payer 302 and a payee 304 using the intermediary of fund transfer manager 306. Fund transfer manager 306 may be a financial institution, bank, savings and loan, payment processing network, credit union, credit or debit card network, etc., although the present invention is not limited to being implemented using such organizations. Fund transfer manager 306 may perform services for payer 302 and/or payee 304 in addition to the transfer of funds into a deposit account, such as management of credit or debit accounts, payment processing for credit or debit account purchases, etc.

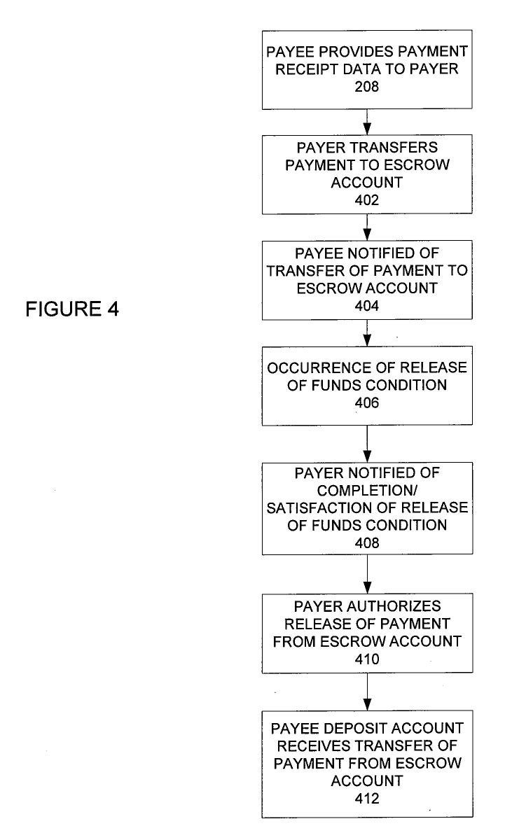

Fund transfer manager 306 serves as an intermediary between payer 302 and payee 304, performing some or all of the function(s) needed to facilitate the transfer of funds from an account or device associated with payer 302 to an account or device associated with payee 304. In this regard, fund transfer manager 306 may perform one or more functions such as account maintenance, deposit account management, transaction or user authorization and/or verification, transaction settlement, or the provision of escrow or dispute resolution services (as will be described in greater detail with reference to FIG. 4), for example.

For a typical transaction that may be performed using the inventive method and system, a prospective payee will have previously established an account with fund transfer manager 306, or with an entity in communication with fund transfer manager 306 (such as a bank, savings institution, credit or debit card network, payment processing network, etc.). The account will be provisioned with a deposit or deposit-only feature or function, typically by establishing a deposit account (for example, a form of savings or checking account) and associating a specific account number or other identifying data with that account (or with a feature or function of the account). In some embodiments, the account number or other identifying data may be a string of alphanumeric characters. Use of the associated account number or other identifying data (with or without additional authentication, verification, or other access control data, as may be required) for the deposit feature or function will enable a transfer of funds into the deposit account. For example, in the case of a credit card account, the account may be associated with a second number or data string that identifies the associated deposit account.

Payer 302 will typically initiate a fund transfer to payee 304 by using a payment mechanism 312 and appropriate access device 314 to instruct fund transfer manager 306 to perform a transfer of funds to payee 304. Payment mechanism 312 may take one of several forms, for example a credit card, a debit card, a membership card for a specified institution, a mobile device (e.g., a wireless phone or PDA) containing a data storage element that is configured to function as an electronic wallet, a personal check, smart card, a data storage element such as a pre-paid or re-loadable balance card, or any other suitable form. Payment mechanism 312 will typically be capable of providing identification and authentication or other access control data to fund transfer manager 306 via access device 314. Access device 314 may take the form of a kiosk, banking terminal, point of sale terminal, automated teller machine (ATM), wire transfer terminal, card reader, a terminal capable of communicating with a wireless phone or similar device via a RF link, a desktop computer capable of communication with fund transfer manager 306 over a network, a telephony device (with or without associated IVR functionality), or any other suitable element.

The use of payment mechanism 312 and access device 314 enables payer 302 to access or identify a source of funds account 310 from which a desired amount may be transferred to payee 304 by deposit into an associated deposit account 322. Source of funds account 310 may be, or linked to, a credit card account, debit card account, savings account, checking account, wire transfer account, or other suitable form of account in which payer 302 maintains funds. Account 310 may be maintained by a bank, savings institution, credit union, payment processor network, or other suitable entity. Fund transfer manager 306 may be the same entity that maintains account 310, or may be a separate entity in communication with the entity maintaining account 310. Similarly, deposit account 322 may be, or linked to, a credit card account, debit card account, savings account, checking account, wire transfer account, or other suitable form of account in which payee 304 maintains funds. Fund transfer manager 306 may be the same entity that maintains account 322, or may be a separate entity in communication with the entity maintaining account 322.

As described, in some embodiments of the invention, payer 302 will utilize payment mechanism 312 in conjunction with access device 314 to communicate a fund transfer request to fund transfer manager 306. The fund transfer request will typically identify the account from which to transfer the funds and the account into which the funds are to be deposited. As discussed, the account into which the funds are to be deposited will be associated with the payee and will typically be a deposit-only account or be provided with a deposit-only function. Fund transfer manager 306 acts to coordinate the transfer of funds from source of funds account 310 to deposit account 322. In some embodiments, this transfer may be initiated by a transfer instruction 330 issued by fund transfer manager 306 to source of funds account 310 (or to the institution or organization responsible for managing the account). Further, in some embodiments, deposit account 322 (or the institution or organization responsible for managing the account) may issue a transfer confirmation 332 to fund transfer manager 306 upon completion of the transfer operation. The transfer may be executed directly by manager 306 if the manager is responsible for maintenance of the relevant accounts, or may be accomplished indirectly via instructions or commands provided to the entities responsible for the accounts.

The funds transferred or credited to the deposit account 322 associated with payee 304 may be accessed by payee 304 using an appropriate access device 320. Access device 320 may take the form of a kiosk, banking terminal, point of sale terminal, automated teller machine (ATM), wire transfer terminal, card reader, a terminal capable of communicating with a wireless phone or similar device via a RF link, a desktop computer capable of communication with fund transfer manager 306 over a network, a telephony device (with or without associated IVR functionality), or any other suitable element. Access device 320 may be used to transfer data regarding the fund transfer transaction to receipt mechanism 318, where receipt mechanism 318 may take one of several forms, for example a credit card, a debit card, a membership card for a specified institution, a mobile device (e.g., a wireless phone or PDA) containing a data storage element that is configured to function as an electronic wallet, a smart card, a data storage element such as a pre-paid or re-loadable balance card, or any other suitable form.

Upon transfer of data to receipt mechanism 318, payee 304 may obtain access to the transferred funds via any suitable method. If receipt mechanism 318 is a portable payment device such as a credit or debit card, the card may be presented to a card reader, kiosk, or ATM machine, or the account information relevant to the card's credit or debit function may be presented to another entity over a network connection to complete a transaction. In this scenario, a portable payment device may function to store data regarding, or account access information for, the balance of a deposit-only account, as well as account data for a credit and/or debit function that may be used to make purchases based on the balance of the deposit-only account. Thus, in some embodiments, a credit or debit card may be used to access funds transferred into a deposit account belonging to the holder of the credit or debit card. In this case the invention enables person-to-person fund transfers using a credit or debit card, where the deposit account is associated with the credit or debit account for the recipient of the payment. Further, the payer may use a credit or debit card as part of a process of providing the funds to be transferred to the payee's deposit account.

In an illustrative embodiment, the deposit only payee account may have an account number 000000 associated with it, and the deposit only payee account may be linked to the payee's debit or credit card account (it is understood that a “debit or credit card account” may allow for payment by other payment device form factors such as mobile phones, key fobs, etc.) For example, the payee may have a credit card account with the account number 111111. If $100 is deposited by the payer into the account number 000000, the payee's credit card account may thereafter be credited $100. A similar process could be used if the payee's debit card account is linked to the deposit only account.

As discussed, in some embodiments, payment mechanism 312 and/or receipt mechanism 318 may be incorporated into a mobile device, such as a portable computer, mobile phone, PDA, smart card, or the like. In such an embodiment, the payment and/or receipt mechanism may include a data storage element, such as a SIM card, flash memory, or other data storage element in which account information is stored. In such an embodiment, the payment and/or receipt mechanism may be configured to function as an electronic wallet. Further, in some embodiments, the mobile device may be configured to communicate with access device 314 or 320 using a wireless link, such as a RF (e.g., near field communications) or infrared communications link. In such embodiments the mobile device may be used by a payer to initiate a fund transfer and/or store data regarding the account or accounts from which funds are to be transferred. Similarly, a mobile device may be used by the payee to receive data confirming transfer of the funds to the payee's deposit-only account and to store data regarding the account or accounts into which the funds are transferred. Note that the payer, payee, or both may be individuals, businesses, or other suitable organizations, and that the transfer of funds may be used to pay for a good or service, obtain entry to a venue, or other suitable purpose. In all such uses, the payer is protected from unauthorized use of credit or debit card data because such data is not provided to the payee.

As mentioned, fund transfer manager 306 may perform functions in addition to those of account management or fund transfer authorization. An example of such an additional function is that of providing an escrow service to enable the control of the fund transfer process by preventing release of the funds to the payee until satisfaction of a predetermined condition or occurrence of a predetermined event.

FIG. 4 is a flowchart illustrating the use of an escrow and/or dispute resolution entity as part of the method of FIG. 2, in accordance with some embodiments of the present invention. As shown in the figure, at some point in the transaction, the payee provides the payment receipt data to the payer (element 208 in FIG. 2 and FIG. 4). The payer uses the payment receipt data to transfer payment for the transaction to an escrow account maintained by the escrow account manager (which, as noted may be the fund transfer manager 306) (stage 402). The escrow account functions as a holding account for the funds or a portion of the funds, with release of the held funds dependent upon the satisfaction of a previously agreed upon condition or occurrence of a previously agreed upon event. In stage 404, the payee is notified by the escrow account manager of the receipt of the funds by the escrow account. The payee may then choose to initiate the steps required to provide the goods or service.

At stage 406 the condition which the release of escrow funds is dependent upon occurs, or the previously agreed upon event that permits release of the escrow funds occurs. Examples of such conditions or events include, but are not limited to, completion by the payee of a stage of the transaction (such as shipping, release of cargo, etc.), or an event such as passage of the goods through customs, etc. Note that in some transactions, a payer may not authorize release of the escrow account funds until receipt and inspection of the goods. If relevant, at stage 408 the payer may be notified of the satisfaction of the release of funds condition or occurrence of the appropriate release of funds event, and in response authorize the release of all or a portion of the funds held in the escrow account (stage 410). In response, the escrow account manager, fund transfer manager or other relevant entity authorizes transfer of the escrow account funds to the payee deposit account (stage 412).

Note that in addition to escrow services, fund transfer manager 306 or the escrow account manager may provide dispute resolution services for the parties to the transaction. In this regard, the funds held in the escrow account could be kept there pending resolution of any disputes between the parties, where such disputes could involve the quality of the goods involved, the performance of the services involved, or other relevant issues. In this way the parties to the transaction would have recourse should some aspect of the transaction not satisfy their expectations. The escrow and/or dispute resolution functions could be managed, provided by, or operated by the fund transfer or escrow account manager, typically for a fee based on the amount or nature of the transaction, or the services provided (escrow alone or dispute resolution in addition to escrow). Note further that in some embodiments, the deposit account function may be time-limited so that the ability of a payer to transfer funds into the deposit account of a payee is limited to certain times, dates, is active for a specified time interval, or limited to the occurrence or non-occurrence of specified events, etc.

It should be understood that certain elements of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method of enabling a transfer of funds from a payer to a payee, comprising:
establishing a deposit function associated with a payee account, the deposit function configured to permit a party other than the payee to only deposit funds into the payee account;
associating payment receipt data with the deposit function;
receiving the payment receipt data from the payer;
receiving identification of an account from which the payer desires to transfer funds into the payee account;
receiving authorization from the payer to transfer the funds; and
transferring the funds into the payee account.

2. The method of claim 1, wherein the payee account is one of a credit card account, a debit card account, a savings account, or a checking account.

3. The method of claim 1, wherein the account from which the payer desires to transfer funds is one of a credit card account, a debit card account, a savings account, or a checking account.

4. The method of claim 1, wherein the payment receipt data is a string of alphanumeric characters.

5. The method of claim 1, wherein receiving the payment receipt data from the payer further comprises receiving the payment receipt data via a kiosk, an ATM, a desktop computer, a telephony device, or a mobile device having wireless connectivity.

6. The method of claim 1, wherein data regarding the account from which the payer desires to transfer funds is stored in a data storage element, the data storage element being contained in one of a credit card, a debit card, a smart card, or a mobile wireless device.

7. The method of claim 1, wherein data regarding the payee account is stored in a data storage element, the data storage element being contained in one of a credit card, a debit card, a smart card, or a mobile wireless device.

8. The method of claim 1, wherein transferring the funds into the payee account further comprises:
transferring the funds into an escrow account; and
transferring the funds from the escrow account to the payee account upon satisfaction of an agreed upon condition or the occurrence of an agreed upon event.

9. A financial services product, comprising an account having an account holder and an associated deposit function, the deposit function identified by identifying data and configured to permit a party other than the account holder to only make deposits into the account in response to the party providing the identifying data.

10. The product of claim 9, wherein the account is one of a credit card account, a debit card account, a savings account or a checking account.

11. The product of claim 9, wherein the identifying data is a string of alphanumeric characters.

12. The product of claim 9, wherein the party providing the identifying data provides the data via a kiosk, an ATM, a desktop computer, a telephony device, or a mobile device having wireless connectivity.

13. A system for the transfer of funds from a payer to a payee, comprising:
means for establishing a deposit account associated with the payee;
means for associating the deposit account with identifying data;
means for receiving the identifying data from the payer; and
a fund transfer manager configured to receive a fund transfer instruction, an identification of a payer account from which to transfer the funds, and the identifying data, and in response, to enable the transfer of the funds from the payer account to the deposit account.

14. The system of claim 13, wherein the fund transfer manager is one of a credit card network, a debit card network, a payment processing network, a bank, or a financial institution.

15. The system of claim 13, further comprising:
means for storing data regarding a balance of the deposit account; and
means for storing data regarding a balance of the payer account.

16. The system of claim 15, wherein the means for storing data regarding a balance of the deposit account is one of a credit card, a debit card, a smart card, or a mobile wireless device.

17. The system of claim 13, wherein the means for storing data regarding a balance of the payer account is one of a credit card, a debit card, a smart card, or a mobile wireless device.

18. The system of claim 13, wherein the fund transfer manager is further configured to enable the transfer of the funds from the payer account to an escrow account, and to enable the transfer of funds from the escrow account to the deposit account upon satisfaction of an agreed upon condition or the occurrence of an agreed upon event.
